(19) United States
(12) Patent Application Publication
(10) Pub. No.: US 2002/0078624 A1
(43) Pub. Date: Jun. 27, 2002

(54) Tree support

(76) Inventors: Stephen J. Saxon, Myrtle Beach, SC (US); Randy L. Donaldson, Myrtle Beach, SC (US)

Correspondence Address: MICHAEL A MANN, NEXSEN PRUET JACOBS & POLLARD LLP, PO DRWR 2426, COLUMBIA, SC, 29202-2426, US

(21) Appl. No.: 09/746,279

(22) Filed: Dec. 22, 2000

(51) Int. Cl. A01G 1/00

(52) U.S. Cl. 47/42

(57) ABSTRACT

A tree support holds the tree in the desired orientation until its root system can hold the tree in that orientation without the need for additional support. The tree support includes a collar and three or more legs. Positioning screws carried by the collar advance radially inward toward the trunk of the tree to engage the trunk and thereby hold the collar in place. The outer ends of the positioning screws are capped with ornamental medallions. The medallions can carry any design or, for example, initials or information about the tree. One embodiment of leg for the tree stand, is a telescoping, rigid leg that pushes against movement of the tree away from normal orientation. The other embodiment of the leg uses tension on wires connected to anchor screws inserted into the ground to hold the tree upright.

### 1. FIELD OF THE INVENTION

The present invention relates generally to devices for use in holding a tree upright, and in particular, to those devices that hold a planted tree upright until its root system establishes itself in the ground.

### 2. BACKGROUND OF THE INVENTION

When a tree is newly planted, its root system will not have penetrated the supporting ground enough for the tree to hold itself upright. Once the root system takes hold, however, the geotropic and phototropic responses of the tree will cause the roots to grow down and the top of the tree to grow toward the sunlight, respectively. If the tree is not planted and held in the proper orientation, or if it should be pushed out of a normal, vertical orientation by the wind, for example, its trunk and root system will be no longer be vertical. It will eventually grow in an upward direction but its trunk may be crooked.

To help a tree grow straight right from the start, homeowners and landscapers will typically use stakes and wires to hold a tree in a correct, vertical orientation until its roots take hold. The wires are wrapped around the trunk of the tree and tied to stakes. At various locations and distances around the tree, the stakes are driven into the ground so that the combined force on the tree from the wires holds the three straight. Usually the wires are cushioned by rubber hoses slid over the wires so that the otherwise bare wires do not bite into the trunk. In other cases boards are used to push the tree to a vertical orientation.

The problem with the use of boards or wires and stakes is their tendency to loosen. An additional problem with using boards is the fact that they are an eyesore. Their use is justified simply because they are convenient and temporary. Thus there remains a need for a better way to assure that a three grows straight but without the negative impact on appearance.

### SUMMARY OF THE INVENTION

According to its major aspects and briefly recited, the present invention is a tree support carrying an ornamental medallion. The tree stand holds the tree in the desired orientation while a feature of the tree stand carries the medallion. The medallion can carry any design, either painted or in low relief, or useful information such as, for example, initials or information about the tree. Preferably the tree support has a collar carrying positioning screws that are capped by the medallions.

The present tree stand has two embodiments. Both embodiments are characterized by a collar with plural positioning screws and plural legs. The positioning screws of both embodiments terminate in pivoting “dogs' feet”. It is primarily in two characteristics of the legs that there is a difference in the two embodiments. These two characteristics are how the legs prevent movement of the legs with respect to the ground and how the legs are adjusted in length. One embodiment uses rigid legs to support the collar and thus push up on the tree from below. Its legs are adjustable in length by a telescoping connection between two or more leg sections. Furthermore, its legs, because they are bearing the weight of the tree they support, have press plates attached to the support legs at roughly right angles to the major axis of each leg. These plates prevent the legs from being pushed too far into the ground, past the press plates, but also facilitate pressing the legs into the ground because the user can step on these plates to drive the pointed end of the leg into the ground.

The second embodiment relies on the mutually applied tension pulling on cables to assist a tree in growing straight. These legs use turnbuckles to change the length of the cables and anchor screws to prevent the legs from coming out of the ground.

A feature of the present invention is the use of pivoting dogs' feet on the ends of the positioning screws to engage the tree without penetrating into the surface of the tree. If the surface is uneven, the dogs pivot until they engage it squarely. These dogs' feet allow the same collar and dogs' feet to be used on trees of different diameters. If the collar is to remain on the tree for a long time, it can periodically be loosened to accommodate growth.

Another feature of the present invention is the use of an ornamental medallion to cap the positioning screws and thereby dress up the present tree support. The term “ornamental medallion” includes both pure ornamentation as well as useful information such as monograms, date of planting, and identification of the type of tree or both.

Still another feature of the present invention is the use of anchor screws for one of the two embodiments of support legs. Anchor screws allow sufficient tension to be applied to the cable, which is important for larger trees and for windy areas.

Yet another feature of the present invention is the use of telescoping leg sections and spring loaded detents to adjust length. This feature makes it easy to adjust the plural legs quickly and evenly.

Other features and their advantages will become apparent to those skilled in the art of tree planting from a careful reading of the Detailed Description of Preferred Embodiments accompanied by the following drawings.

### BRIEF DESCRIPTION OF THE DRAWINGS

In the drawings,

FIG. 1 is a perspective view of tree supports shown in use according to both embodiments of the present invention;

FIG. 2 is a top view is a tree support according to a preferred embodiment of the present invention;

FIG. 3 is a side view of the tree support as shown in FIG. 2;

FIG. 4 is a top view of a tree support according to an alternative preferred embodiment of the present invention; and

FIG. 5 is a side view of the tree support as shown in FIG. 4.

### DETAILED DESCRIPTION OF PREFERRED EMBODIMENTS

The present invention is a tree support; that it, it is a device for holding a newly planted tree in an upright orientation until its root system establishes itself and can hold the tree upright without assistance. At that time, the present invention can be removed or left in place, as desired.

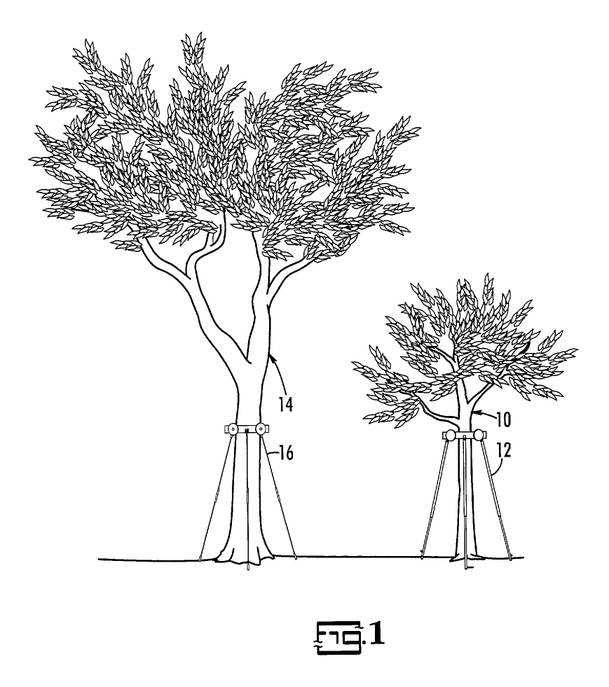

Referring now to FIG. 1, the present tree support can be used for shorter trees and taller trees. Although either embodiment can be used with either type of tree, the first embodiment that has rigid legs is preferred for shorter trees and the second embodiment that uses tension on cables is preferred for taller trees. The shorter tree 10 in FIG. 1 is shown supported by a tree support 12; a taller tree 14 is shown with tree support 16. These two embodiments for tree supports will be described in turn.

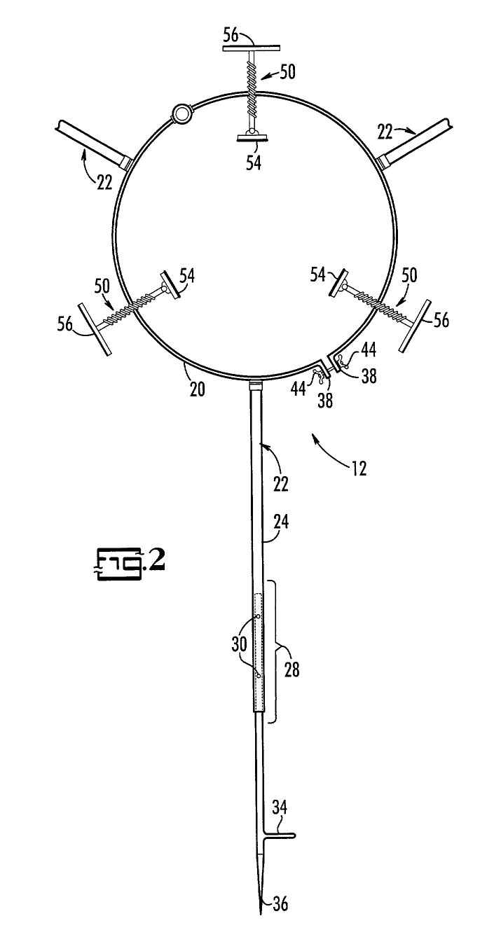

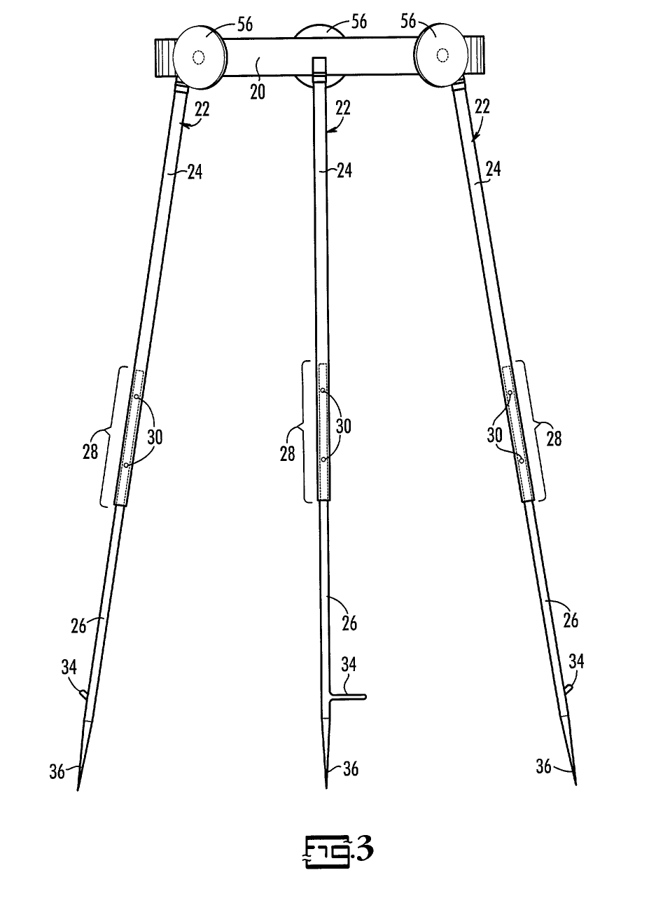

Tree support 12 is shown in more detail in FIGS. 2 and 3. Tree support 12 has a collar 20 and at least three legs 22. Each leg 22 has an upper section 24 and a lower section 26 with a telescopic connection 28 joining them. The relative positions of upper and lower sections 24, 26, are fixed using spring-loaded ball detents 30. A press plate 34 is fastened near the end of each leg 22 and lies in a plane roughly perpendicular to the long axis of that leg 22. The end 36 of each leg 22 is pointed for ease of insertion into the ground. Plate 34 limits the extent to which leg 22 can be inserted and also facilitates insertion by serving as a place to apply foot pressure.

Legs 22 are hingedly joined to collar 20. Collar 20 is generally circular but is not a continuous circle. Rather, it has an opening along its length where two flanges 38 are formed and holes 40 are formed therein for receiving a bolt 42 secured by nuts 44.

Collar 20 is dimensioned to be larger than any tree to which it will be applied. In order to secure it to a trunk, at least three positioning screws 50 are used. Positioning screws 50 are threadedly carried by collar 20 and advance in a direction radial to the plane of collar 20 and toward the central axis of collar 20. Each positioning screw 50 terminates on its inner end with a pivoting dogs' foot 54 that will engage a tree trunk, pivoting as needed to fully engage trunk about an axis parallel to the axis defined by the central axis of collar 20.

In use, collar 20 is spread to receive a tree trunk. Once encircling a trunk, collar 20 is raised or lowered to a suitable place along the length of trunk where it does not interfere with limbs or knots. Collar 20 is bolted using a bolt 42 and a nut 44. Legs 22 are extended to reach the ground by telescopingly sliding upper section 24 with respect to lower section 26. Legs 22 are spread and end 36 is inserted into the ground by stepping on press plates 34 and pressing. Detents 30 lock upper section 24 with respect to lower section 26 of each leg 22. Next positioning screws 50 are advanced toward the trunk of tree so that dogs' feet 54 engage tree trunk.

The telescopic connection 28 allows leg 22 to be adjusted in length, as upper section 24 and lower section 26 are moved relative to each other. Press plate 34 limits the movement of leg 22 with respect to the ground by preventing leg 22 from being pushed further into the ground when, for example, the wind blows against short tree 10.

Capping the ends of each positioning screw 50 and opposing dog's foot 54 is a medallion 56. Medallion 56 contains either a purely ornamental design, functional information or a combination of both. The functional information can be the date of planting, the type of tree, the name or initials of the owner or person for whom the tree was planted. The ornamentation can include a painted surface or a surface formed in low relief

When the tree's root system has established itself, and can hold the tree upright on its own, tree support can be removed or at least legs 22 if it is desired to leave collar 20 in place. Preferably, legs 22 and collar 20 are made of material that is minimalist and colored in a subdued shade of green or in black so as to be either attractive or at least not unattractive.

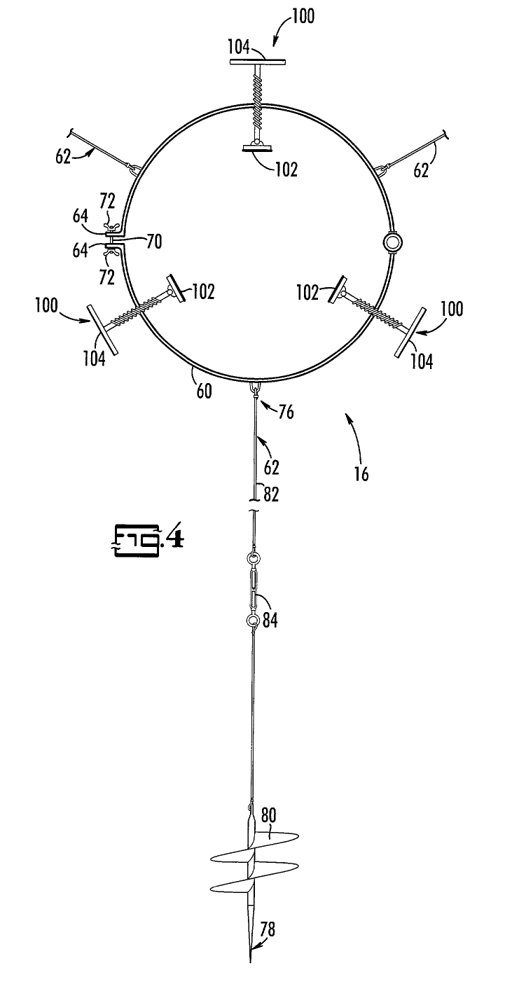

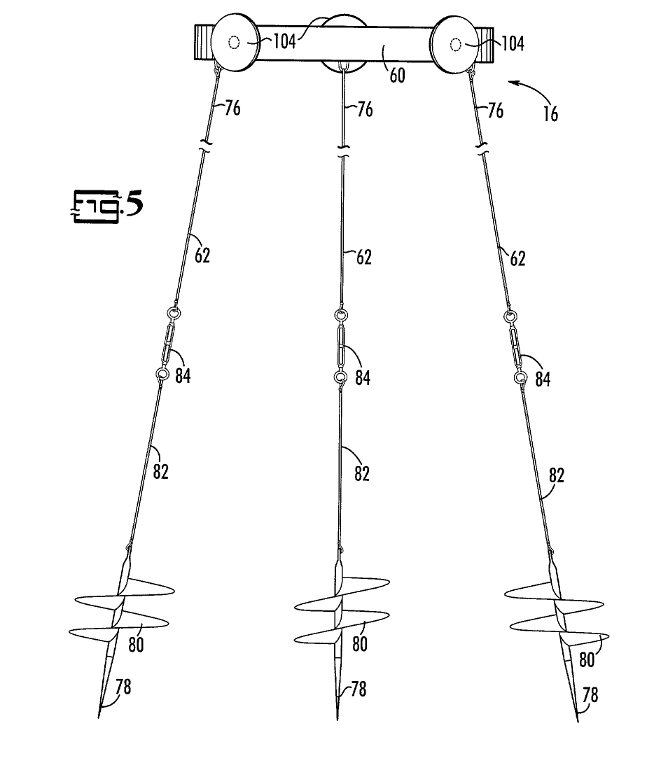

Referring now to FIGS. 4 and 5, where a second preferred embodiment of the present invention is shown, tree support 16 has a collar 60 and legs 62. Collar 60, as before, is circular and terminates with two flanges 64 with holes formed therein to receive a bolt 70 secured by nuts 72.

Legs 62 have a first end 76 hingedly attached to collar 60 and a second end 78 that is pointed for ease of insertion into the ground. Legs 62 have an anchor screw 80 near second end 78 that can be rotated into the ground to secure end 78. Between first end 76 and second end 78 is a cable 82, preferably “airplane” wire for strength and lightness, and a turnbuckle 84.

Collar 60 is also dimensioned to be larger than any tree trunk. In order to secure it to a trunk, at least three positioning screws 100 are used. Positioning screws 100 are threadedly carried by collar 60 and advance in a direction radial to the plane of collar 60 and toward the central axis of collar 60. Each positioning screw 100 terminates on its inner end with a pivoting dogs' foot 102 that will engage a tree trunk, pivoting as needed to fully engage trunk about an axis parallel to the axis defined by the central axis of collar 60. Positioning screws 100 are each capped with a medallion 104 that can carry ornamentation or useful information or both.

In use, collar 60 is positioned and fastened as with collar 20. Then legs 62 are spread and anchor screws 80 are inserted into the ground by rotating them while pressing them into the ground. Next, tension is applied to cable 82 by rotation of turnbuckles 84.

Anchor screws limit movement of legs 62 with respect to the ground because the prevent the legs from being pulled free when, for example, the wind blows against taller tree 14 and turnbuckles 84 allow the length of legs 62 to be adjusted by shortening or lengthening cable 82.

Various modifications and substitutions to the foregoing preferred embodiments will be apparent to those skilled in the art of tree planting without departing from the spirit and scope of the present invention, defined by the appended claims.

What is claimed is:

1. A device for supporting a tree, said device comprising:
a collar;
plural legs extending from said collar; and
a medallion carried by said collar.

2. The device as recited in claim 1, wherein further comprising a positioning screw carried by said collar.

3. The device as recited in claim 2, wherein said medallion caps said positioning screw.

4. The device as recited in claim 2, wherein said positioning screw terminates in a dog's foot.

5. The device as recited in claim 2, wherein said positioning screw terminates is a pivoting dog's foot.

6. The device as recited in claim 1, wherein said plural legs have means for adjusting the lengths of said plural legs.

7. The device as recited in claim 6, wherein said adjusting mean s is selected from the group consisting of turnbuckles and telescoping connections.

8. The device as recited in claim 1, wherein said plural legs carry means for limiting movement of said plural legs with respect to the ground.

9. The device as recited in claim 7, wherein said limiting means is selected from the group consisting of press plates and anchor screws.

10. A device for supporting a tree planted in the ground, said device comprising:
a collar;
plural legs extending from said collar, each leg of said plural legs being pointed so that said each leg can penetrate the ground; and
plural positioning screws carried by said collar.

11. The device as recited in claim 10, wherein said positioning screws terminate in dogs' feet.

12. The device as recited in claim 10, wherein said positioning screws terminate in pivoting dogs' feet.

13. The device as recited in claim 10, wherein said plural legs have means for adjusting the lengths of said plural legs.

14. The device as recited in claim 13, wherein said adjusting means is selected from the group consisting of turnbuckles and telescoping connections.

15. The device as recited in claim 10, wherein said plural legs carry means for limiting movement of said plural legs with respect to the ground.

16. The device as recited in claim 15, wherein said limiting means is selected from the group consisting of press plates and anchor screws.

17. A device for supporting a tree planted in the ground, said device comprising:
a collar;
plural legs, said plural legs having a first end and a second, opposing end, said second end extending from said collar and said first end being pointed;
means carried by said plural legs near said first end for limiting movement of said legs with respect to the ground; and
means carried by said plural legs for adjusting the lengths of said plural legs.

18. The device as recited in claim 17, further comprising a medallion carried by said collar.

19. The device as recited in claim 17, further comprising positioning screws carried by said collar.

20. The device as recited in claim 17, wherein said limiting means is an anchor screw and said adjusting means is a turnbuckle.
